(19) United States
(12) Patent Application Publication
(10) Pub. No.: US 2005/0170179 A1
(43) Pub. Date: Aug. 4, 2005

(54) Thermoplastic-polymer-based powder and its use for obtaining a rough coating

(76) Inventors: Marc Audenaert, Bernay (FR); Michel Foucher, Bernay (FR); Isabelle Letellier-Delahaye, Bourg Achard (FR); Alain Vitoux, Bernay (FR)

Correspondence Address: Arkema Inc., 2000 Market St., Philadelphia, PA, 19103, US

(21) Appl. No.: 11/043,665

(22) Filed: Jan. 26, 2005

Related U.S. Application Data
(60) Provisional application No. 60/540,464, filed on Jan. 30, 2004.

(51) Int. Cl. B05D 1/04; B32B 1/00

(52) U.S. Cl. 428/402; 427/458

(57) ABSTRACT

The present invention relates to the use of a powder for coating articles, this powder comprising, by volume, 99 to 65% of at least one thermoplastic polymer and 1 to 35% of beads of a material that retains its initial shape at the processing temperatures for obtaining the coating. This powder may be prepared by simply dry-blending the constituents. The invention also relates to this powder. The invention relates in particular to rough coatings obtained from powders, for a dishwasher basket, which contain solid or hollow glass or ceramic beads added by dry-blending them with the polyamide powder. Because of their roughness, these coatings improve the drying in dishwashers. The addition of glass beads furthermore improves the quality of the fluidization.

This application claims benefit, under U.S.C. §119(e) of U.S. provisional application 60/540,464, filed Jan. 30, 2004.

### FIELD OF THE INVENTION

The present invention relates to a powder based on thermoplastic polymer(s) and to its use for coating articles. This powder is useful in processes for covering an article with a film arising from the melting of a thin layer of powder deposited beforehand on the article. More precisely, the powder of the invention is a blend of thermoplastic polymer(s) and of beads of a material (for example glass or ceramic) that retains its initial shape at the processing temperatures for obtaining the coating.

At the present time, several industrial processes for covering an article by melting a powder exist.

The first process is electrostatic powder coating, which consists in charging the powder with static electricity and in bringing it into contact with the article to be covered, which is at zero potential. For example, the powder is injected into an electrostatic spray gun which charges the said powder by the corona effect, by triboelectrification or by a combination of both. The powder thus charged is sprayed onto the object to be covered, which is at zero potential. According to another form of electrostatic powder coating, the article at zero potential is immersed in a fluidized bed of charged powder. Within the fluidized bed is powder with which it is desired to cover the article. This powder is in the form of small solid particles, for example with a size between 0.01 and 1 mm, of any shape, which are in a state of fluidization within the bed owing to the presence of air or any other gas. The powder may be charged by electrodes, by the corona effect, or by any device placed inside and/or outside the fluidized bed in order to charge it by the triboelectric effect. The article covered with powder is then placed in an oven at a temperature high enough to provide a coating, by melting the powder and causing a film to be formed. For example, for a nylon-11 powder, it is sufficient to heat to 220° C.

The second process consists in preheating the object to be covered to a temperature above the melting point of the powder. Once the article is hot, it is immediately immersed in a fluidized bed of the powder, the powder melts on contact with the hot article and forms a film. A solid covering is thus provided. This process is also called the “fluidized-bed dip coating” process.

The powder paint of the present invention can be used in both processes.

### PRIOR ART AND THE TECHNICAL PROBLEM

The invention relates to the field of high-performance thermoplastic polymer (advantageously polyamide) coatings that provide articles, and advantageously metal articles, with corrosion protection. It relates more particularly to powders (denoted also by “powder paints”) that are applied by a fluidized-bed dip process. The invention also relates to a thermoplastic polymer powder composition for obtaining a rough, and therefore hydrophilic, coating. This is particularly useful in the case of dishwasher baskets, thus improving the drying characteristics of the dishwasher.

It is known that a hydrophilic surface increases spreading of the drops of water that come into contact with this surface. This characteristic makes it possible for a film of water to form on the surface with a smaller amount of water, thereby promoting the flow of water. Moreover, an isolated drop of water evaporates more quickly when it is in contact with a hydrophilic surface. It is also known that a drop of water on a surface spreads out more the rougher the surface. A rougher surface can therefore be likened to a more hydrophilic surface.

Patent Application JP1075539 published on 22 Mar. 1989 describes the increase in wettability of a surface by sandblasting the surface (i.e. blasting the latter with hard particles) and then by treating it with UV or ozone. Patent DE19842095 describes the improvement in the water-draining from dishwasher baskets by plasma-treating them. Patent DE4113211 describes a similar process. U.S. Pat. No. 5,482,768 describes a wettable coating on a substrate, this coating consisting of two layers in which the layer in contact with the substrate is formed from a temperature-resistant polymer containing polymer particles that decompose by heating. U.S. Pat. No. 6,660,363 describes an article with a rough coating comprising elevations and depressions, where the distance between the elevations is between 5 and 200 μm and the height of these elevations is between 5 and 100 μm. The elevations are made of hydrophobic polymer. U.S. Pat. No. 5,882,739 relates to dishwasher baskets and describes the improvement in the drying rate after a plasma treatment or a sulphonation treatment of the plastic coating. Patent DE 19917151 proposes to obtain a rough surface on dishwasher baskets in various ways:
by modifying the processing parameters (time and temperature) to create unmelted regions;
by providing plastic particles of a different particle size;
by applying a paint that makes the surface rough; and
by incorporating fillers (TiO₂, SiO₂, magnesium oxide, or mixtures of crystals) in the coating before complete solidification of the latter (plasticized state).

Patent application US 20010032825 describes a coating that spreads water on its surface, having a roughness Rz greater than or equal to 5 microns, for the purpose of evaporating the water more rapidly. No means of obtaining this roughness is described.

U.S. Pat. No. 5,882,739 and DE 19917151 make use of a two-step process:
first step: application of a plastic coating;
second step: modification of the surface of the coating either by chemical treatment, in order to make it more hydrophilic, or by incorporation of mineral fillers before complete solidification of the coating.

Patent application US 20010032825 specifies only that it is necessary to have a roughness Rz greater than 5 microns in order to improve the water run-off properties without explaining how this is achieved. Moreover, no information explains why it is necessary for Rz to be greater than or equal to 5 microns.

A much simpler means has now been found for obtaining a rough coating. All that is required is to add glass or ceramic beads to the thermoplastic polymer powder before coating the dishwasher basket and then to carry out the coating operation as if an ordinary thermoplastic polymer powder were used.

### BRIEF DESCRIPTION OF THE INVENTION

The present invention relates to the use of a powder for coating articles, this powder comprising, by volume, 99 to 65% of at least one thermoplastic polymer and 1 to 35% of beads of a material that retains its initial shape at the processing temperatures for obtaining the coating.

This powder may be prepared by simply dry-blending the constituents.

The invention also relates to this powder, that is to say the invention relates to a powder comprising, by volume, 99 to 65% of at least one thermoplastic polymer and 1 to 35% of beads of a material that retains its initial shape at the processing temperatures for obtaining the coating of an article by melting the thermoplastic polymer, causing it to form a film.

The present invention also relates to a process for covering an article with a film that arises from the melting of a thin layer of powder in which:
(a) the above powder is used in electrified form, this powder having been charged by any means;
(b) the article is brought up to the powder or else the article and the powder are brought into contact with each other, the article being at zero potential or a potential sufficient to cover it with powder; and
(c) the article covered with powder is then placed in an oven at a temperature high enough to obtain the coating film by the powder melting.

The present invention also relates to a process for covering an article with a film that arises from the melting of a thin layer of powder in which:
(a) the above powder is used in fluidized-bed form;
(b) the article to be covered is heated to a temperature high enough for the powder to melt upon contact with it;
(c) the article is dipped into the fluidized bed for a time long enough for it to be covered with powder; and
(d) the article is removed from the fluidized bed.

Advantageously, this process is used.

The invention also relates to articles having a rough coating obtained by the use of the above powders.

The present invention does not involve any surface treatment or any process to modify the initial coating obtained (such as painting the initial coating, incorporation of fillers while the initial coating is cooling). The powder composition of the invention makes it possible to obtain a rough dishwasher basket coating in a single step.

The invention relates in particular to rough coatings obtained from powders, for a dishwasher basket, which contain solid or hollow glass or ceramic beads added by dry-blending them with the thermoplastic polymer powder. Because of their roughness, these coatings improve the drying in dishwashers. The addition of glass beads furthermore improves the quality of the fluidization.

### DETAILED DESCRIPTION OF THE INVENTION

With regard to the thermoplastic polymer, PVC, polyolefins and polyamides are used for example. It is advantageous to use polyamides. The term “polyamide” is understood to mean products resulting from the condensation:
of one or more amino acids, such as aminocaproic, 7-aminoheptanoic, 11-aminoundecanoic and 12-aminododecanoic acids or of one or more lactams, such as caprolactam, oenantholactam and lauryllactam;
of one or more salts or mixtures of diamines, such as hexamethylenediamine, dodecamethylenediamine, metaxylyenediamine, bis(p-aminocyclohexyl)methane and trimethylhexamethylenediamine with diacids such as isophthalic, terephthalic, adipic, azelaic, suberic, sebacic and dodecanedicarboxylic acids; or mixtures of several of these monomers, resulting in copolyamides. Advantageously, aliphatic polyamides are used.

The aliphatic polyamides may be chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides having either more than 90% of 11 units or more than 90% of 12 units.

By way of examples of aliphatic polyamides resulting from the condensation of an aliphatic diamine having from 6 to 12 carbon atoms and of an aliphatic diacid having from 9 to 12 carbon atoms, mention may be made of:
PA-6,12 resulting from the condensation of hexamethylenediamine and 1,12-dodecanedioic acid;
PA-9,12 resulting from the condensation of the C₉ diamine and 1,12-dodecanedioic acid;
PA-10,10, resulting from the condensation of the C₁₀ diamine and 1,10-decanedioic acid; and
PA-10,12 resulting from the condensation of the C₉ diamine and 1,12-dodecanedioic acid.

As regards the 11/12 copolyamides having either more than 90% of 11 units or more than 90% of 12 units, these result from the condensation of 1-aminoundecanoic acid with lauryllactam (or the C₁₂ α,Ω-amino acid.

Advantageously, PA-11 and PA-12 are used.

With regard to the beads of material, this material is any material that retains its initial shape at the processing temperatures for obtaining the coating. Mention may be made by way of example of crosslinked polymers, glass and ceramic. Advantageously, the material is glass or ceramic. The beads may be hollow or solid and their size is advantageously between 20 and 200 μm.

With regard to the preparation of the powder, this may be carried out by simply dry-blending the constituents. The thermoplastic polymer powder has a particle size that can vary from 10 to 1000 μm. The term “dry blend” is used as opposed to a blend in which the thermoplastic polymer is in the melt state. Standard mixers for powder products, for example Henschel® mixers, may be used. The mixing is carried out at normal temperature and pressure. The mixing time must be long enough in order for the blend to be homogeneous.

The proportion by volume of beads of the material is advantageously between 5 and 20% per 95 and 80% of thermoplastic polymer, respectively.

The powder of the invention may also include UV stabilizers, antioxidants, dyes, pigments, fire retardants, bactericides etc. These products are preferably incorporated into the thermoplastic polymer before it is reduced to a powder.

With regard to the articles that it is desired to coat, metal articles may be mentioned for example. As examples of metals, mention may be made of aluminium, aluminium alloys, steel and its alloys. The invention is useful for dishwasher baskets. Optionally, a surface pretreatment is carried out on the article before it is covered with powder. These are conventional pretreatments used in the coating industry, namely phosphatizing, degreasing, shot-peening.

The invention also relates to this powder. The composition of this powder, the nature and the proportions of its constituents are those described above for its use.

### EXAMPLES

The following examples illustrate the invention without limiting its scope.

### Example 1

1000 parts (by weight) of a white PA-11 powder used for coating dishwasher baskets and 150 parts of solid glass beads having a relative density of 2.5 and a size such that 100% of the glass beads pass through a 125 micron screen and 0 to 10% pass through a 53 micron screen were dry-blended by means of a Henschel mixer (modified PA-11 powder A). This proportion corresponds to about 7% by volume of beads.

The powder was fluidized and a preheated dishwasher basket was dipped into the fluidized powder. The basket was heated and cooled in the same way as in the case of the coating obtained from the PA-11 powder (containing no glass beads). The roughness of the coating was measured using a Perthometer. The results are given in Table 1.

TABLE 1

| Coating obtained | Roughness Rz (μm) |
|---|---|
| PA-11 powder | 2 ± 0.5 |
| Modified PA-11 powder A | 4.5 ± 0.5 |

### Example 2

1000 parts (by weight) of a white PA-11 powder used for coating dishwasher baskets and 300 parts of solid glass beads having a relative density of 2.5 and a size such that 100% of the glass beads pass through a 125 micron screen and 0 to 10% pass through a 53 micron screen were dry-blended by means of a Henschel mixer (modified PA-11 powder B). This proportion corresponds to about 15% by volume of beads. The powder was fluidized and a preheated dishwasher basket was dipped into the fluidized powder. The basket was heated and cooled in the same way as in the case of the coating obtained from the PA-11 powder (containing no glass beads). The roughness of the coating was measured using a Perthometer. The results are given in Table 2.

TABLE 2

| Coating obtained | Roughness Rz (μm) |
|---|---|
| PA-11 powder | 2 ± 0.5 |
| Modified PA-11 powder B | 17 ± 2 |

Using a method such as that described in the IEC 436 standard (methods of measuring the aptitude to the function of electrical dishwashers), it may be demonstrated that the use of the powder compositions given in these two examples for coating dishwasher baskets helps to improve the drying of the dishes during a washing cycle.

The use of spherical glass beads also improves the fluidization of the powder, something which a person skilled in the art may assess qualitatively.

1. A powder for use in coating articles comprising by volume, 99 to 65 percent of at least one thermoplastic polymer and 1 to 35 percent of beads of a material that retains its initial shape at the processing temperatures for obtaining the coating.

2. The powder of claim 1 wherein the thermoplastic polymer is chosen from the polyamides PA-11 and PA-12.

3. The powder of claim 1 wherein the powder has a particle size of between 10 and 1000 μm.

4. The powder of claim 1 wherein the size of the beads of the material that retains its initial shape at the processing temperatures for obtaining the coating is between 20 and 200 μm.

5. The powder of claim 1 wherein said material that retains its initial shape at the processing temperatures for obtaining the coating is chosen from glass and ceramic.

6. The powder of claim 1 wherein the proportion by volume of beads of the material is between 5 and 20% per 95 and 80% of thermoplastic polymer, respectively.

7. A process for covering an article with a film comprising the steps of:
a) charging by any means a powder, comprising, by volume, 99 to 65 percent of at least one thermoplastic polymer and 1 to 35 percent of beads of a material that retains its initial shape at the processing temperatures for obtaining the coating to produce a powder in an electrified form;
(b) bringing the article and powder into contact with each other, the article being at zero potential or a potential sufficient to cover it with powder; and
(c) placing the article covered with powder in an oven at a temperature high enough to obtain the coating film by the powder melting.

8. A process for covering an article with a film comprising the steps of:
a) obtaining a powder in fluidised-bed form, the powder comprising, by volume, 99 to 65 percent of at least one thermoplastic polymer and 1 to 35 percent of beads of a material that retains its initial shape at the processing temperatures for obtaining the coating to produce a powder in an electrified form;
(b) heating the article to be covered to a temperature high enough for the powder to melt upon contact with it;
(c) dipping the article into the fluidized bed for a time long enough for it to be covered with powder; and
(d) removing the article from the fluidized bed.

9. An article having a rough coating, comprising an article coated with a powder comprising, by volume, 99 to 65% of at least one thermoplastic polymer and 1 to 35% of beads of a material that retains its initial shape at the processing temperatures for obtaining the coating of an article by melting of the thermoplastic polymer, causing it to form a film.

10. The article of claim 9, wherein said article is a dishwasher basket.
